(19) United States
(12) Patent Application Publication
(10) Pub. No.: US 2005/0081981 A1
(43) Pub. Date: Apr. 21, 2005

(54) Groove glazed window sash and fabrication method

(76) Inventor: Kurt E. Heikkila, Marine on the St. Croix, MN (US)

Correspondence Address: WOMBLE CARLYLE SANDRIDGE & RICE, P.O. Box 7037, Atlanta, GA, 30357-0037, US

(21) Appl. No.: 10/686,791

(22) Filed: Oct. 16, 2003

(51) Int. Cl. G02B 1/00; G02C 7/00; B32B 17/00; C03C 27/00

(52) U.S. Cl. 156/109; 156/293

(57) ABSTRACT

A method of applying a grooved lineal to the edge portion of a glass unit in the formation of a window component is provided. The method includes the steps of applying a triggerable sealant to the groove of the lineal, urging the edge portion of the glass unit into the groove, and triggering the sealant to form a seal between the groove and the edge portion of the glass unit. In one embodiment, the triggerable sealant is a dual state adhesive that can be placed in a first non-adhesive state by application of a temporary adhesion blocker. The lineal is urged onto the edge of the glass unit while the adhesive is in this first state and held in place until the adhesive transitions to its second adhesive state to bond and seal the glass within the groove.

### TECHNICAL FIELD

This invention relates generally to fenestration and more specifically to methods of fabricating window components such as window sashes.

### BACKGROUND

Groove glazed window sashes are common in fenestration. In general, a groove glazed sash comprises a sheet of glass, a multi-sheet integrated glass unit, or other transparent or translucent pane mounted within a sash frame formed by rails and stiles. The rails and stiles, otherwise referred to as the lineals, are configured with a continuous inside groove and the peripheral edges of the glass unit fit into and are sealed within the grooves. The ends of the lineals are configured to fit and join securely together to form a structurally sound and aesthetically pleasing joint at each corner of the sash. This may be accomplished in a variety of ways such as, for example, by mortise and tenon joinery, miter joints, by combinations thereof, or by other suitable joinery techniques. Adhesives and, in some cases, mechanical fasteners typically are used at the joints to enhance the structural integrity of the completed sash, which is sized to fit within a window frame.

It is important when fabricating groove glazed window sashes that the peripheral edges of the glass unit be sealed tightly within the grooves of the lineals to prevent drafts and leakage of water into the grooves. In the past, glass units have been sealed within the grooves using a variety of glazing techniques such as, for instance, applying a silicone RTV or other sealant to the interface between the glass and the groove, by extruding lineals with rubber fins on the walls of the grooves, or by applying a pliable rubberized gasket to the glass/groove interface. Such glazing materials can be applied to the grooves prior to insertion of the glass unit, or alternatively may be applied after the glass unit is mounted in the sash. Examples of sashes and sash fabrication employing these and other glazing techniques may be found in U.S. Pat. Nos. 4,122,633; 4,105,814; 4,477,507; 4,480,417; 4,775,570; and 5,503,700.

While prior groove glazed sashes and methods of fabricating them have been successful, there nevertheless have been inherent problems and shortcomings. For example, the fabrication of groove glazed sashes generally has been a somewhat inefficient multi-step process involving partial assembly of the rails and stiles, mounting of the glass unit, completion of assembly, and, in some cases, application of a gasket or other glazing material. Further, some glazing materials have not proven to provide a reliable seal between the edges of the glass unit and the grooves, especially after prolonged periods of exposure to the elements. For example, the seal provided by a rubberized gasket commonly is not continuous around the entire periphery of the glass unit because of discontinuities or poor fitting of the gaskets at the corners of the sash. Gaskets also can dry out and crack over time, allowing water to leak into the grooves and degrade the window sash. Silicone and other sealants also can allow leakage and are difficult and messy to handle during the fabrication process.

A need exists for an improved method of fabricating a groove glazed window sash that is efficient, that can be carried out in a rapid single step process at one assembly station, that provides a superior and complete seal between the grooves of the sash frame and the glass unit, and that results in a sash with dimensions that are highly accurate and repeatable from sash to sash. It is to the provision of such a fabrication technique and a groove glazed sash resulting therefrom that the present invention is primarily directed.

### SUMMARY OF THE INVENTION

Briefly described, the present invention comprises an improved method of fabricating a groove glazed window sash and an improved sash resulting therefrom. In a preferred embodiment, the lineals of the sash, which form the rails and stiles, are made of a hollow profile extruded thermoplastic composite material. One example of such a material is Fibrex® produced by Andersen Corporation of Bayport Minn. The ends of the lineals preferably are joined and secured together with corner pieces, known as corner keys, that are disposed within the lineals at the corners of the sash and secured with hot melt adhesives. The joined lineals form the sash frame. While the invention will be described herein within the context of extruded Fibrex lineals and corner key joinery, it will be understood that the method of the invention is equally applicable to the fabrication of sashes with traditional grooved wooden lineals or with lineals made of any other type of material, and interconnected with any type of joinery.

The method of the invention includes the use of a triggerable sealing mechanism to adhere and seal the edges of the glass unit within the grooves of the sash frame. In the preferred embodiment, the triggerable sealing mechanism incorporates a class of adhesives systems known as dual state adhesives. A dual state adhesive is a unique adhesive that can exist in a first non-adhesive state, but that can be acted upon by an appropriate trigger to transition to a second adhesive state. Examples of dual state adhesive systems include heat activated adhesives, wherein the application of heat triggers a transition from a non-adhesive to an adhesive state, adhesives for which adhesion can be temporarily blocked by an adhesive blocking agent, and adhesives for which a state transition is triggered by application of a coupling agent to the adhesive. The invention will be described herein primarily within the context of the second type of triggerable sealing mechanism, a dual state adhesive and a temporary adhesive blocker. It should be understood, however, that any and all types of dual state adhesives and, more generally, any type of triggerable sealing mechanism may be used in the method of this invention and all are considered to be within the scope of the invention.

In one aspect, the present invention is a method of fabricating a groove glazed window sash having a glass unit with peripheral edges captured in grooves formed in surrounding lineals of the sash. The method comprises providing lineal stock, preferably made of an extruded thermoplastic composite material, that will be cut and joined to form a sash frame. The lineal stock is formed with a groove along an inside edge and the groove has opposed inwardly facing walls. A strip of foam-backed double-sided adhesive tape is applied to at least one and preferable both of the opposed walls of the groove. The tape has one face with a pressure sensitive adhesive that adheres the strip to the wall of the groove, and an opposite face that carries a dual state adhesive layer. A removable release liner may cover the dual state adhesive layer to protect the adhesive layer until just before assembly of a sash.

For sash fabrication, lineal stock with its adhesive lined groove is cut into appropriate lengths to form the rails and stiles of the sash. The ends of the rails and stiles are configured to be joined and secured together, preferably with corner keys. The rails and stiles along with an appropriately sized glass unit are placed in a clamping jig and the release liner, if any, is removed to expose the dual state adhesive along the walls of the groove. A temporary adhesive blocking agent, such as isopropanol in one embodiment, is applied to the dual state adhesive to place the adhesive temporarily in its first or non-adhesive state. The blocking agent also provides a measure of lubrication that persists while the adhesive is in its first state. With the blocking agent applied and the adhesive in its non-adhesive state, the clamping jig is activated to urge the grooves of the rails and stiles progressively onto the peripheral edges of the glass unit until the ends of the rails and stiles, preferably with inserted corner keys, meet to form the corners of the sash frame. The corners may be secured and sealed together by, for example, injecting hot melt adhesive into the corners.

As the rails and stiles are pressed onto the edges of the glass unit, the glass slides between the foam-backed adhesive strips. Since the dual state adhesive is in its non-adhesive state as a result of application of the adhesive blocker, the glass slides easily across the adhesive, aided by the lubricating qualities of the blocker. Preferably, the width of the groove is selected so that the foam of the foam-backed strips is compressed by the advancing edge of the glass to between about zero and fifty percent (0-50%) of it uncompressed thickness. In this way, the adhesive layer is pressed firmly against the surface of the glass by the compression of the foam. The clamping jig then holds the rails and stiles in place for a predetermined length of time until the adhesive blocking agent dissipates and the dual state adhesive transitions to its second or adhesive state. This transition causes the adhesive to adhere to and form a continuous water tight seal against the surface of the glass around the entire periphery of the glass. The clamping jig is then retracted and the finished groove glazed window sash can be removed for incorporation into a window unit.

Thus, an improved grooved glazed window sash and method of fabrication is now provided that effectively and efficiently addresses the problems and shortcomings of the prior art. Fabrication is carried out in one easily automated operation at a single fabrication station and can be accomplished in a fraction of the time previously required to make traditional groove glazed window sashes. The resulting groove glazed window sash is superior to the prior art because its dimensions are carefully controlled and highly repeatable. Further, the dual state adhesive bonds the lineals securely to the glass, forming a monolithic sash structure that is strong and highly stable. Finally, the seal provided between the glass and the grooves is virtually impenetrable by moisture and there are no discontinuities or regions of poor seal at the corners or anywhere else around the periphery of the glass, as is common with gasket-type sealing techniques. These and other objects, features, and advantages of the invention will become more apparent upon review of the detailed description set forth below taken in conjunction with the annexed drawing figures, which are briefly described as follows.

### BRIEF DESCRIPTION OF THE DRAWINGS

FIG. 1 is a perspective exploded view of a window sash assembly method that embodies principles of the invention in a preferred form. The figure illustrates one preferred embodiment of the fabrication method of the invention.

FIGS. 2a-2c are cross-sectional views illustrating progressive stages of the process of urging the adhesive lined grooves of lineals onto the peripheral edge portions of a glass unit.

FIG. 3. is a plan view of a window sash fabricated according to the invention and illustrating lineal bow that can occur due to springback.

FIG. 4 is a plan view of a window sash illustrating one method of compensating for springback-induced lineal bow during fabrication of the sash.

FIG. 5 is a cross-sectional view illustrating another method of reducing springback-induced lineal bow during the fabrication method of the invention.

FIG. 6 is a cross-sectional view illustrating yet another method of reducing springback-induced lineal bow during the fabrication method of the invention.

FIG. 7 is a cross-sectional view illustrating still another method of reducing springback-induced lineal bow during the fabrication method of the invention.

### DETAILED DESCRIPTION OF THE PREFERRED EMBODIMENTS

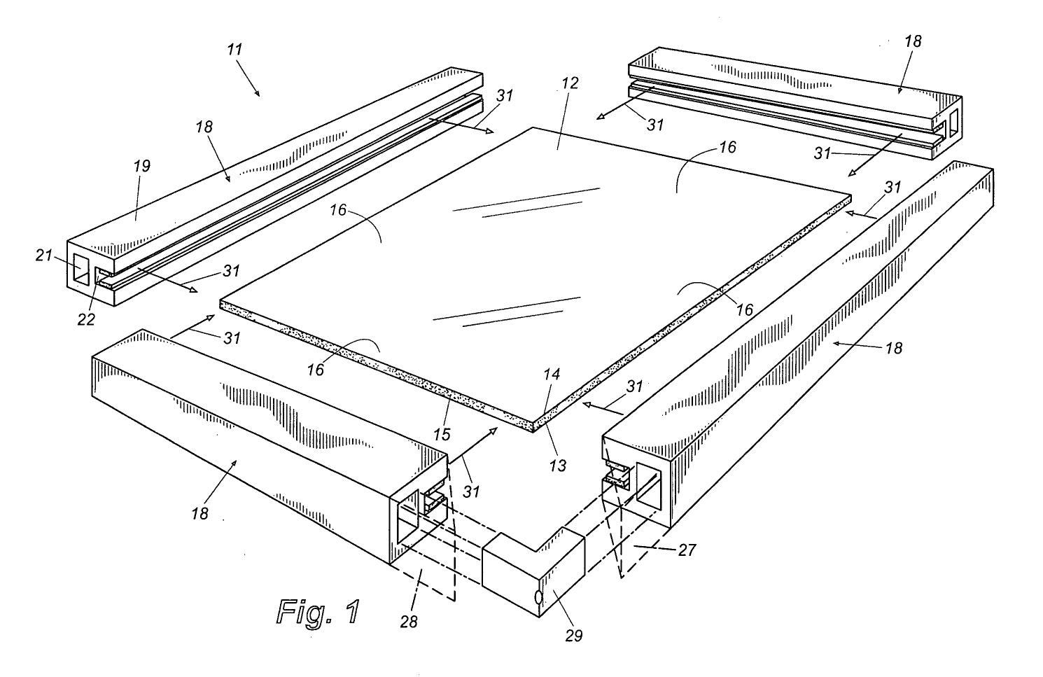

Reference is now made in more detail to the drawing figures, wherein like numerals refer, where appropriate, to like parts throughout the several views. FIG. 1 is a perspective partially exploded view of a window sash assembly illustrating preferred components and method steps of the present invention. The sash assembly 11 comprises a glass unit 12 made up of two spaced panes 13 and 14 of glass separated by an insulating space, which may be filled with an appropriate gas such as argon, as is known in the art. The panes 13 and 14 of glass are maintained in their spaced apart relationship and the space between them is sealed by a spacer 15, which extends around the periphery of the glass unit between the panes. While such a dual pane insulated glass unit is preferred, it should be understood that many other types of transparent or translucent material sheets might be used within the scope of the invention. For example, the glass unit might be comprised of a single pane of glass or more than two spaced apart or layered panes. Furthermore, the glass unit might be a decorative member comprising, for example, assembled pieces of stained glass. In fact, the glass unit might not be made of glass at all, but instead might be a plastic or Plexiglas™ panel or multiple layers of such panels or combinations of all of the above. Thus, the term “glass unit” when used herein and in the claims is to be construed as including the preferred dual insulated glass unit shown in the drawings as well as any other sheet of glass, plastic, decorative member, or combinations thereof.

A set of 4 lineals 18, having been cut from lineal stock, form, when secured together at their ends, the rails and stiles of the finished sash. In the preferred embodiment, the lineals 18 are made of an extruded thermoplastic composite material such as Fibrex® and are formed with a substantially hollow profile, as indicated at 21. The profiles of lineals 18 in the drawing figures are deliberately oversimplified for clarity of presentation and discussion of salient features the invention. For instance, the simplified lineals 18 have a body 19 with a simple square, hollow cross-section and a groove that is formed and extends along an inside edge of the lineal. It will be understood by those of skill in this art that lineals for groove glazed window sashes are in fact extruded, milled, or otherwise formed with a wide variety of more complex profiles and decorative features that are a function of application specific parameters. The invention disclosed and claimed herein is applicable to all such profiles. In any event, a common feature of lineals for making groove glazed window sashes is that they are configured with a groove 22 that extends along their inside edges and the grooves 22 are sized to receive the peripheral edge portions 16 of a glass unit.

The lineals 18 are cut from lineal stock, and machined if necessary, such that their ends are configured to be joined and secured together to form the frame of the sash. In this regard, the ends may be coped and shaped, be joined by mortise and tenon joinery, miter joints, by combinations thereof, or by other suitable joinery techniques. Adhesives and, in some cases, mechanical fasteners typically are used at the joints to enhance the structural integrity of the completed sash. When the lineals are formed of hollow profile extruded thermoplastic composite material as in the preferred embodiments, the ends of the lineals are sometimes mitered, as illustrated by phantom lines in FIG. 1. The mitered ends can be joined securely together by, for example, sonic welding techniques or, more preferably for the present invention, by mechanical corner keys 29. Corner keys 29 are configured with legs that extend into and fit within the hollow profiles of lineals to join the ends of the lineals together. Hot melt adhesives can then be injected into the corners through specially designed passages to bond the corner keys within the lineals and thereby to secure the ends of the lineals permanently together. Corner keys for use in the fabrication of window components are described in some detail in U.S. patent application Ser. No. 09/825,914, filed Apr. 4, 2001, the disclosure of which is hereby incorporated by reference as if fully set forth herein.

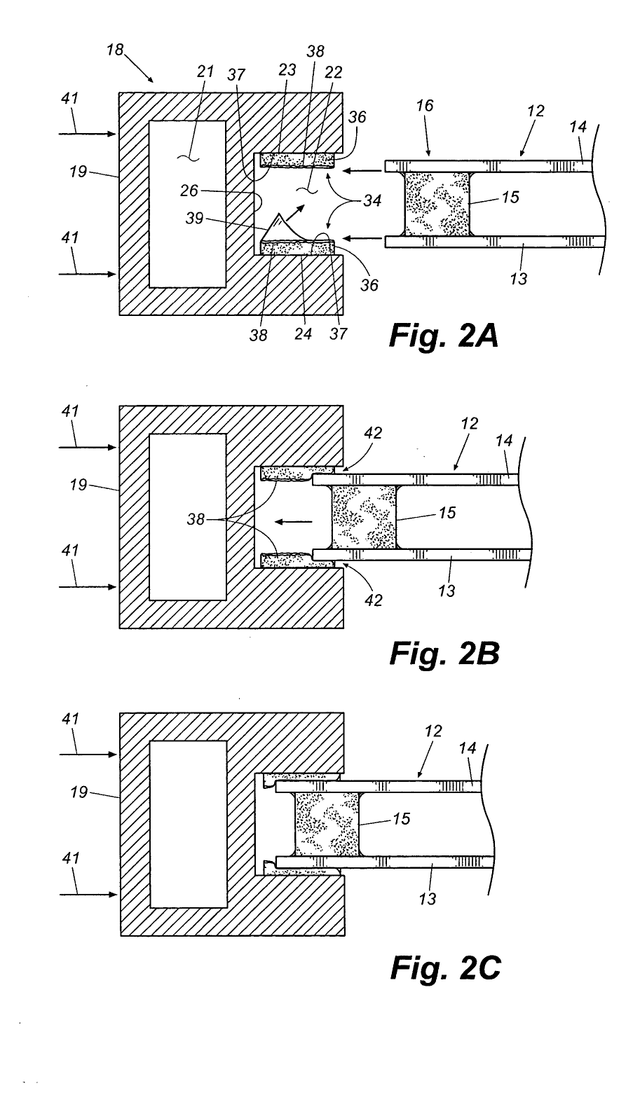

The grooves 22 formed along the inside edges of the lineals have opposed walls 23 and 24 and a floor 26 (FIG. 2a). As best seen in FIG. 2a, but also visible in FIG. 1, a dual state adhesive is applied to at least one and preferably to each of the opposed walls of the groove 22. The dual state adhesive is applied to the groove walls in the form of a strip of foam-backed double-sided adhesive tape 34, such as VHB® tape available from the Minnesota Mining and Manufacturing Corporation (3M) of St. Paul, Minn. The strip of tape 34 has a compressible foam backing 36 with a pressure sensitive contact adhesive 37 attaching the strip to the groove wall and a dual state adhesive 38 applied to its exposed face. In the case of VHB® tape, the dual state adhesive is an acrylic pressure-sensitive adhesive polymer, but other dual state adhesives may be selected. 3M VHB tape and a silane coupling agent, whether or not mixed with an isopropanol or other adhesive blocking agent, for bonding glass is disclosed in detail in U.S. Patent application Ser. No. ______, filed concurrently herewith by the 3M Corporation. The disclosure of this concurrently filed patent application is hereby incorporated by reference as if fully set forth herein.

Thus, the faces of the strips of tape 34 carrying the dual state adhesive face inwardly toward each other within the groove 22. A removable release liner 39 may be applied over the dual state adhesive layer to protect the adhesive from dirt, moisture, and other debris during storage and machining of the lineal components. The release liner may then be removed just prior to assembly of a window sash according to the fabrication method of the invention.

Preferably, the double-sided foam-backed tape strips are applied to the grooves of lineal stock as a part of the fabrication of such stock. The stock, with attached dual state adhesive strips, can then be stored for extended periods of time and then retrieved from storage, cut, and machined in preparation for the fabrication of groove glazed window sashes according to the invention.

With the foregoing structural background, the fundamental method of the invention will now be discussed with reference principally to FIGS. 1-2c. Lineal stock with pre-attached dual state adhesive strips is retrieved and appropriately cut to form the rails and stiles of window sashes to be fabricated. The ends of the rails and stiles are configured, i.e. mitered, copped, or otherwise formed, to be joined together. In the preferred embodiment, the ends are configured to be joined together with corner keys 29, however they might be joinable with joinery, be sonically weldable, or otherwise be capable of being joined together to form a sash frame. An appropriately sized glass unit 12, which is a dual pane insulated glass unit in the drawings, is provided and the glass unit, rails and stiles, and corner keys if used, are mounted in a multi-dimensional clamping jig (not shown in the drawings) with the rails and stiles surrounding the glass unit as shown in FIG. 1.

If the dual state adhesive 38 on the adhesive strips 34 is protected by a release layer 39, this release layer is removed and discarded to expose the dual state adhesive within the grooves of the lineals. A temporary adhesion blocker is then applied to the exposed dual state adhesive within the grooves to cause the adhesive to enter its first or non-adhesive state. In the preferred embodiment, the temporary adhesion blocker comprises isopropanol, which is a rather volatile liquid that disperses by evaporation in a relatively short period of time. Isopropanol, when applied to the dual state adhesive, also exhibits a temporary lubrication, which is useful in carrying out the method of the invention. The adhesion blocker may also be provided with coupling agents such as, for instance, a silane, which strengthens the adhesive bond provided by the dual state adhesive when it transitions to its second adhesive state after dissipation of the adhesion blocking agent.

With the components in the clamping jig, the release layer removed, and the temporary adhesion blocker applied, the clamping jig is activated. The clamping jig is configured to apply inward force to the lineals 18 as indicated by arrows 41 in the FIGS. 2a-2c. This inward force moves the lineals toward the peripheral edges of the glass unit, as indicated by arrows 31 in FIG. 1, until the edges of the glass unit begin to be received into the grooves of the lineals. As the lineals continue to be moved inwardly by the clamping jig, the edges of the glass unit engage and begin to compress the foam-backed adhesive strips within the grooves (FIG. 2b). Since the dual state adhesive on the strips is in its first or non-adhesive state by virtue of the application of the adhesion blocker, and since the adhesion blocker provides temporary lubrication, the edge portions of the glass unit slide with relatively little friction across the surfaces of the strips until the ends of the lineals meet to be joined permanently together. At this point, the edge portions of the glass unit are completely received in the grooves (FIG. 2c). If the lineals are joined with corner keys, appropriate hot melt adhesive can be injected into the corners while the assembly is still in the clamping jig to secure and seal the corners.

With the lineals urged by the clamping jig completely onto the edge portions of the glass unit and the corners of the lineals joined together, the clamping jig is retained in its clamping position while the temporary adhesion blocking agent dissipates. This step of the method insures that the lineals are held securely in place until the dual state adhesive transitions to its second or adhesive state upon dissipation of the temporary adhesion blocking agent. Upon the transition, the dual state adhesive immediately bonds securely to the glass unit, forming a water tight seal between the walls of the groove and the glass. In addition, the secure adhesive bond between the glass and the lineals results in a window sash having a substantially monolithic structure that is strong and very dimensionally stable. In other words, the lineals no longer provide all of the strength of the sash, but, instead, the glass and lineals bond together to form a unitary structure with the glass itself providing strength and rigidity.

When a sufficient time has elapsed for the dual state adhesive to transition to its adhesive state and bond to the glass, the clamping jig is retracted and the finished window sash can be removed from the jig for incorporation into a window unit. It will thus be seen that the window sash is fabricated in a substantially single, mostly automated step at a single work station. In addition, since the tolerances of the clamping jig can be closely controlled, window sashes with highly repeatable dimensions, squareness, and dimensional stability can be produced time and time again. Another advantage of the method of the invention is that it produces a groove glazed window sash with a highly reliable and completely continuous water tight seal around the entire periphery of the glass unit. All of these advantages are realized through a unique fabrication methodology that is substantially simpler and significantly faster than prior art methods of assembling groove glazed window sashes.

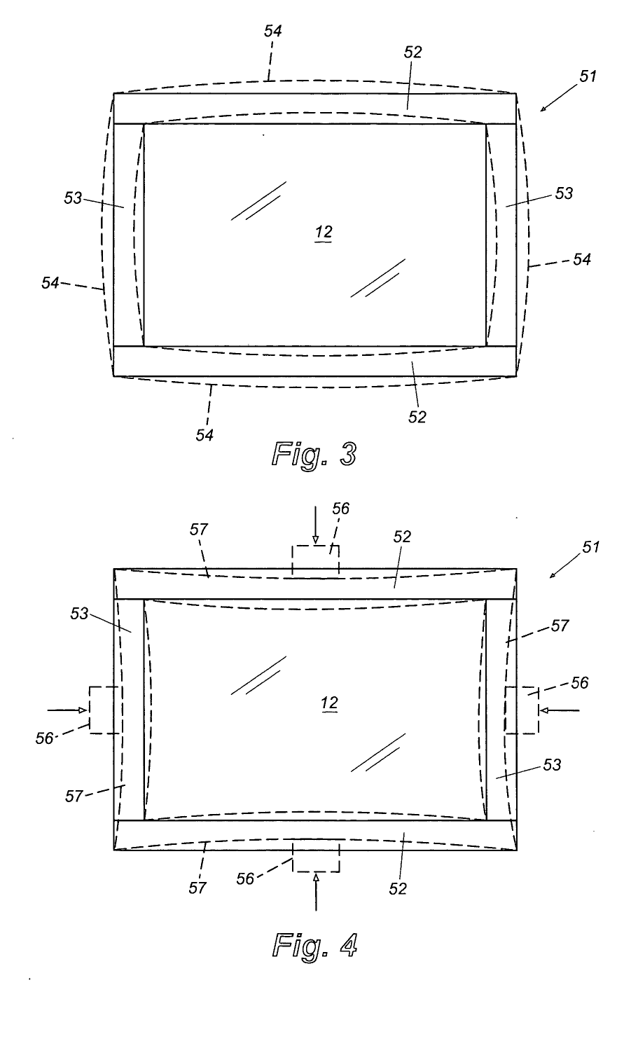

One phenomenon that has been observed when fabricating window sashes according to the invention is outward lineal bowing as a result of springback. Referring to FIGS. 2a-2c as the groove 22 begins to be urged progressively onto the edge portion 16 of the glass unit, the foam tape strips 34 can undergo significant deformation in the form of shear, compression, and possibly rollover at the leading edges of the strips. As the glass moves further into the groove, this deformation approaches pure compression, perhaps due in part to the lubricating effect of the adhesion blocking agent. Despite the eventual smooth and well lubricated movement of the glass into the groove, significant stresses from the initial insertion may remain in the foam strips. As a result, after the edge portion 16 of the glass unit is fully inserted into the groove 22 (FIG. 2c) and the clamping jig has been retracted, there is a tendency for the foam strips to spring back slightly, urging the lineals slightly outwardly. Since the ends of the lineals are securely attached together, this slight outward urging of the lineals results in a slight bowing of the lineals in their mid sections. Referring to FIG. 3, an assembled window sash 51 is shown with a glass unit 12 surrounded by lineals 52. The slight outward bowing of the lineals is indicated in a highly exaggerated form for clarity by phantom lines 54 in FIG. 3. This slight bowing effect is undesirable for several reasons including its effect on the fit of the sash in a window unit and its effect on the fit and finish of auxiliary components such as decorative mullion grids that may be installed in the sash.

Several solutions to the phenomenon of lineal bowing have been discovered by the inventors. One such solution is illustrated in FIG. 4 and is referred to as a reverse bowing compensation. This solution involves modifying the clamping jig so that when the jig is activated, it urges the center portions of the lineals slightly further inwardly than the end portions, thereby producing a slight reverse bow in the lineals as indicated by phantom lines 57 in FIG. 4. The lineals are held in this configuration for a time sufficient to allow the adhesion blocking agent to dissipate causing the dual state adhesive to bond to the glass. When the clamping jig is released, the lineals still tend to bow slightly outwardly due to springback of the foam strips, but this outward bowing is just compensated by the inward bow induced in the lineals during clamping. The result is that the lineals of the finished window sash are straight and true.

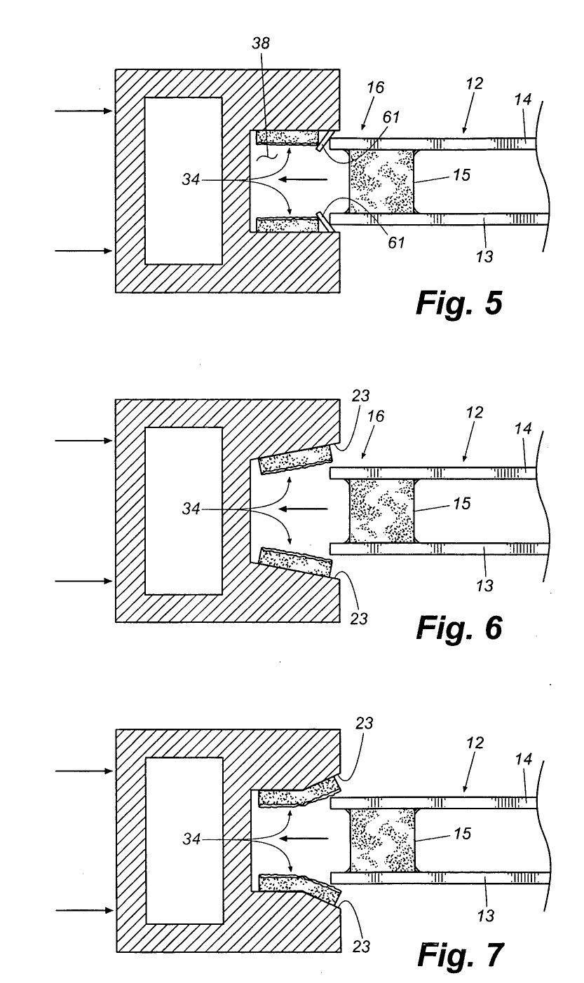

Other solutions to lineal bowing are illustrated in FIGS. 5, 6, and 7 respectively. In FIG. 5, the lineals are formed with a pair of co-extruded flexible entry tabs 61 that are positioned outboard of the leading edges of the foam strips 34. As the edge portions 15 of a glass unit move into the groove 22, the glass first engages the flexible entry tabs 61 causing them to pivot toward and eventually engage the leading edges of the foam strips. As the glass advances further, the entry tabs 61 cover and compress the leading edges of the strips effectively insulating these leading edges from the moving glass edges. This has been found to reduce significantly the shear forces, rollover, and adhesive scraping that otherwise can be caused by the moving glass engaging the leading edges of the strips. Since it is these types of deformations that cause a significant portion of the springback of the foam strips after clamping, the springback has been found to be substantially reduced or eliminated, which, in turn, eliminates the resultant lineal bowing.

As an alternative to entry tabs, it has been found that splaying the walls 23 of the groove 22 slightly outwardly, as illustrated in exaggerated form in FIG. 6, also reduces or eliminates springback induced lineal bowing. In this solution, the advancing edge portions 16 of the glass engage the foam strips 34 in a gradual manner, which reduces the deformations that can otherwise occur at the leading edges of the strips. Again, springback has been found to be significantly reduced, thus reducing or eliminating the consequent lineal bowing.

As an alternative to splaying the entire widths of the walls 23 as in FIG. 6, springback and attendant lineal bowing can also be reduced or eliminated by chamfering the leading edge portions of the walls as illustrated in FIG. 7. In this solution, foam strip deformation at the leading edges of the strips is reduced, just as in the solution of FIG. 6, by the gradual engagement of the advancing glass edge with the strip. However, since the back portions of the foam strips remain parallel to each other, an improved seal is formed between the dual state adhesive layers and the glass when the edge portion 16 of the glass is fully inserted into the groove.

While specific solutions to the phenomenon of springback induced lineal bowing are presented, other solutions also may be successful. For instance, combinations of splayed or chamfered groove walls, entry tabs, and a compensating counter bow may be used to produce a sash with repeatable straight lineals. It also is thought that inducing relatively high frequency vibrations in the glass and/or in the lineals as the glass edges move progressively into the grooves may ease the stresses that cause deformations in the leading edges of the foam strips. Such vibration techniques also may enhance the lubricating effect of the adhesion blocking agent and thus reduce the coefficient of sliding friction between the adhesive layer and the surface of the glass. These and other solutions to lineal bowing might be contemplated by those of skill in the art, and all such solutions are considered to be within the scope of the invention. In its broadest terms, therefore, this aspect of the invention simply comprises reducing or eliminating lineal bowing as a component of the fabrication method of the invention.

As mentioned above, the method of this invention has been described in the context of one preferred triggerable sealing mechanism for use in fabricating groove glazed window sashes; namely, a dual state adhesive and adhesive blocker. However, other types of triggerable sealing mechanisms exist and all are considered to be within the scope of the invention. Some examples are as follows. An alternative dual state adhesive, for instance, is a pressure sensitive adhesive with a heat or radiation fusible protective layer. Adhesive systems of this type are disclosed, for example, in U.S. Pat. No. 3,027,271. Other types of heat activated adhesives are disclosed in U.S. Pat. Nos. 4,135,033 and 6,540,865. Adhesives of this type can be attached to one side of a foam backing having a second adhesive layer on the other side, and applied to one or both walls of a lineal groove. After assembly of the sash unit, the lineals can then be heated or exposed to appropriate radiation to activate the fusible protective layer and cause the adhesive to bond to the glass.

Yet another heat activated adhesive system that may be implemented in the present invention is disclosed in U.S. Pat. No. 6,059,555. In this system, a tape incorporates a thin electrically conductive layer along with layers of hot melt adhesive. A hand held induction apparatus is provided, which is passed over the assembled sash unit to heat the tape by inducing electrical current in the conductive layer, causing the adhesive to bond to the glass. Devices of this type are available, for example, from Nexicor LLC of Loveland, Ohio, and have been demonstrated by the inventors. Since some of the tapes used in this system are relatively thin, it may be useful to provide a foam or other resilient backing to improve conformability of the sealant layer. As an alternative to inductively coupled electrical current, the tape of these systems can be heated by passing a current directly through the conductive layer, as disclosed in U.S. Pat. No. 4,555,607.

Other triggerable sealing mechanisms might include an expandable sealing medium on the walls of the groove that can exist in a compressed state to allow insertion of the edge of the glass unit into the groove and then be triggered to expand against the surface of the glass to form a seal. An expandable foam strip or a radiation or heat expandable sealant are examples of this type of mechanical triggerable sealing mechanism. Still another type of triggerable sealing mechanism may be obtained by applying one or more beads of silicone along the walls of the groove. The beads of silicone may be applied contemporaneously with the extrusions of lineal stock or may be applied as a part of the sash fabrication process. Further, one of the beads is envisioned as comprising a slow curing silicone while the other is a faster curing silicone. The beads may be completely cured at the time of sash fabrication or may be only partially cured so that the surfaces of the beads are cured or “skinned over” while the interior remains uncured and malleable. In either event, a temporary lubricant is applied to the silicone beads and the grooves of the lineals are urged onto the edge portions of a glass unit. When the lubricant dissipates, the silicone beads bond firmly to the glass forming a seal.

In the broad sense, then, the current method of the current invention includes the use of any type of triggerable sealing mechanism that allows insertion of the glass edges into lineal grooves and thereafter is triggered to bond to and form a seal against the glass. In fact, the invention is not limited to the fabrication of window sashes or even window components, but is applicable to and encompasses groove glazing of glass units in the fabrication of, for example, doors, sidelights, and similar items of manufacture.

The invention has been described herein in terms of preferred embodiments and methodologies that represent the best mode known to the inventors of carrying out the invention. It will be understood by those of skill in the art, however, that a wide variety of modifications, substitutions, and alternatives to the illustrated embodiments might be made without departing from the spirit and scope of the invention as set forth in the claims.

1-3. (canceled)

4. A method of assembling a groove glazed window component wherein at least one grooved lineal is applied to an edge portion of a glass unit, said method comprising the steps of:
(a) applying a sealant to the groove of the lineal, the sealant having an exposed surface bearing a dual state adhesive;
(b) applying a temporary adhesion blocker to the dual state adhesive to place the dual state adhesive in a first substantially non-adhesive state;
(c) urging the edge portion of the glass unit into the groove while the dual state adhesive is in its first substantially non-adhesive state; and
(d) allowing the temporary adhesion blocker to dissipate thereby placing the dual state adhesive in a second substantially adhesive state to bond and seal the glass unit within the groove.

5. A method of assembling a groove glazed window component as claimed in claim 4 and wherein a plurality of groove lineals are applied to a corresponding plurality of edge portions of the glass unit, and wherein step (c) further comprises urging the plurality of edge portions of the glass unit into the grooves of respective lineals substantially concurrently.

6. A method of assembling a groove glazed window component as claimed in claim 5 and wherein the glass unit is substantially rectangular with four edge portions and wherein four grooved lineals are applied to the four edge portions to form a rectangular window component.

7. A method of assembling a groove glazed window component as claimed in claim 6 and wherein the window component is a sash.

8. A method of assembling a groove glazed window component as claimed in claim 5 and wherein the grooved lineals are extruded lineals.

9. A method of assembling a groove glazed window component as claimed in claim 8 and wherein the grooved lineals are extruded Fibrex®.

10. A method of assembling a groove glazed window component as claimed in claim 8 and wherein the grooved lineals are configured to meet at their ends as the edge portions of the glass unit are urged into their grooves to define a substantially continuous frame around the glass unit.

11. A method of assembling a groove glazed window component as claimed in claim 10 and further comprising the step of joining the ends of the lineals together.

12. A method of assembling a groove glazed window component as claimed in claim 11 and wherein the step of joining the ends of the lineals together comprises welding.

13. A method of assembling a groove glazed window component as claimed in claim 12 and wherein the welding step comprises sonic welding.

14. A method of assembling a groove glazed window component as claimed in claim 11 and wherein the step of joining the ends of the lineals together comprises providing corner keys at the intersections of the lineals, the corner keys locking the ends of the lineals together.

15. A method of assembling a groove glazed window component as claimed in claim 4 and wherein the lineal has ends and a mid portion, the method further comprising the step of bowing the mid portion of the lineal toward the edge portion of the glass unit during step (c).

16. A method of assembling a groove glazed window component as claimed in claim 15 and wherein the glass unit is rectangular having four edge portions and wherein four lineals are applied to said glass unit, each to a corresponding edge portion, and further comprising bowing the mid portions of each lineal toward the corresponding edge portion of the glass unit during step (c).

17. A groove glazed window component assembled by the method of claim 16.

18. A method of assembling a window sash wherein edge portions of a glass unit are captured and sealed within interior grooves of a surrounding frame, the frame being formed by grooved lineals connected at their ends, said method comprising the steps of:
(a) applying a triggerable sealant to the grooves of the lineals;
(b) urging the grooved lineals onto the edge portions of the glass unit until the ends of the lineals meet;
(c) triggering the triggerable sealant to bond and seal the edge portions of the glass unit within the grooved lineals; and
(d) securing the ends of the lineals together to form the frame of the sash.

19. The method of claim 18 and wherein the lineal grooves have walls and wherein step (a) comprises applying a triggerable sealant to at least one wall of the grooves.

20. The method of claim 19 and wherein step (a) comprises applying a triggerable sealant to each wall of the grooves.

21. The method of claim 18 and wherein the lineals have mid portions intermediate the ends of the lineals and wherein step (b) further comprises urging the mid portions of at least one of the lineals further toward the glass unit than the end portions to form a slight inward bow in the lineal.

22. The method of claim 18 and wherein step (d) comprises adhering the ends of the lineals together.

23. The method of claim 18 and wherein step (c) comprises welding the ends of the lineals together.

24. The method of claim 18 and wherein step (c) comprises fastening the ends of the lineals together with mechanical fasteners.

25. The method of claim 24 and wherein the mechanical fasteners comprise corner keys.

26. The method of claim 18 and wherein the lineals are extruded of a composite material.

27. The method of claim 26 and wherein the lineals are extruded of Fibrex®.

28. The method of claim 18 and wherein step (a) comprises applying a dual state adhesive to the grooves of the lineals.

29. The method of claim 28 and further comprising the step, prior to step (b), of applying a temporary adhesion blocker to the dual state adhesive to place the dual state adhesive in a first substantially non-adhesive state.

30. The method of claim 29 and wherein step (c) comprises holding the lineals in place on the glass unit until the action of the temporary adhesion blocker dissipates and the dual state adhesive is placed in a second substantially adhesive state to bond and seal the lineals to the glass unit.

31. A window sash fabricated by the method of claim 18.

32. A method of assembling a window component having a glass unit mounted within the interior groove of a surrounding frame, the frame being formed from a plurality of grooved lineals joined at their ends, said method comprising the steps of:
(a) providing the grooves of the lineals with a triggerable sealant having a first substantially non-adhesive state and a second substantially adhesive state;
(b) placing the triggerable sealant in its first substantially non-adhesive state;
(c) moving the lineals onto corresponding edges of the glass unit until the ends of the lineals meet, the edges of the glass unit extending into the grooves of the lineals and engaging the triggerable sealant;
(d) placing the triggerable sealant in its second substantially adhesive state to bond and seal the edges of the glass unit in the grooves of the lineals; and
(e) securing the ends of the lineals together.

33. The method of claim 32 and wherein step (b) comprises applying a temporary adhesion blocker to the triggerable sealant.

34. The method of claim 33 and wherein step (d) comprises allowing the effects of the temporary adhesion blocker to dissipate.

35. A window component assembled according to the method of claim 32.

36. A fenestration unit incorporating the window component of claim 35.
